(19) United States
(12) Patent Application Publication
(10) Pub. No.: US 2013/0332073 A1
(43) Pub. Date: Dec. 12, 2013

(54) Combination Headband and Tracking Device

(71) Applicant: Willie Mae Thomas, Boston, GA (US)

(72) Inventor: Willie Mae Thomas, Boston, GA (US)

(21) Appl. No.: 13/493,247

(22) Filed: Jun. 11, 2012

(51) Int. Cl. G01C 21/00

(52) U.S. Cl. 701/487

(57) ABSTRACT

A combination headband and tracking device that includes: a headband with a snap attachment mechanism, an elastic band and a camera lens; an ankle bracelet that includes a locking mechanism, an on and off switch and a GPS locator; a charge cord that includes a cord and an electrical plug; and a monitor that includes a volume control, a charge port and a visual display that displays a desired GPS location or a desired video.

### BACKGROUND OF THE INVENTION

1. Field of Invention

The present invention relates to a combination headband and tracking device.

2. Description of Related Art

Currently, there is no compact device that serves as an independent tracking system. Individuals, who desire to document their locations as a safety precaution, are without resource. This is disheartening since there are recurring stories of authorities' potentiality saving lives if a victim's location was promptly confirmed.

### BRIEF DESCRIPTION OF DRAWINGS

FIG. 1 illustrates an overhead front perspective view of a headband of a combination headband and tracking device, according to the present invention.

FIG. 2 illustrates an overhead front perspective view of an ankle bracelet of a combination headband and tracking device, according to the present invention.

FIG. 3 illustrates an overhead perspective view of a charge cord of a combination headband and tracking device, according to the present invention.

FIG. 4A illustrates a front perspective view of a monitor displaying a location of a combination headband and tracking device, according to the present invention.

FIG. 4B illustrates a front perspective view of a monitor displaying a video of a combination headband and tracking device, according to the present invention.

### DETAIL DESCRIPTION

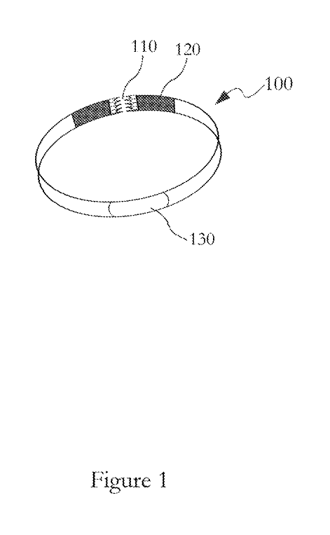

FIG. 1 illustrates an overhead front perspective view of a headband 100 of a combination headband and tracking device, according to the present invention. The headband includes a snap attachment mechanism 110, an elastic band 120 and a camera lens 130.

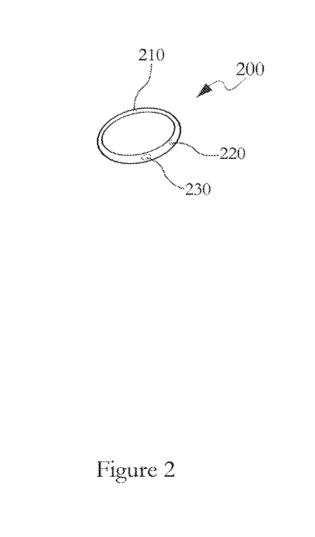

FIG. 2 illustrates an overhead front perspective view of an ankle bracelet 200 of a combination headband and tracking device, according to the present invention. The ankle bracelet 200 includes a locking mechanism 210, an on and off switch 220 and a GPS locator 230.

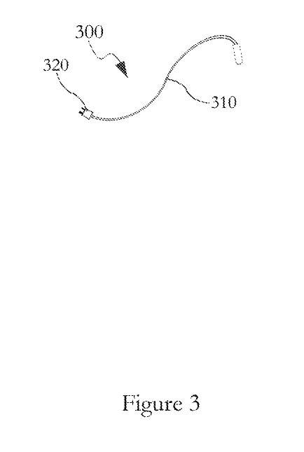

FIG. 3 illustrates an overhead perspective view of a charge cord 300 of a combination headband and tracking device, according to the present invention. The charge cord 300 includes a cord 310 and an electrical plug 320.

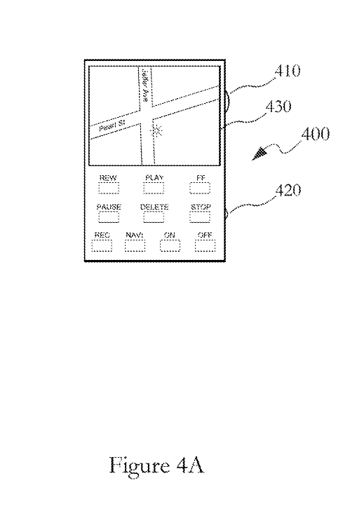

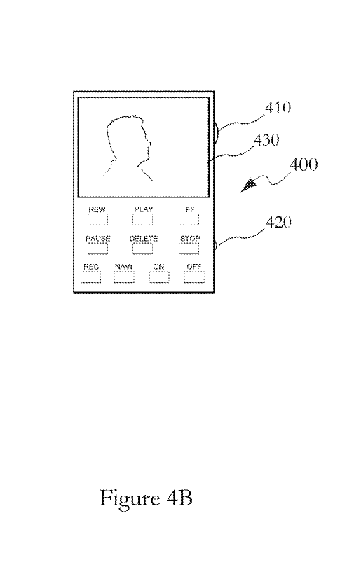

FIG. 4A illustrates a front perspective view of a monitor 400 displaying a location of a combination headband and tracking device, according to the present invention. The monitor 400 includes a volume control 410, a charge port 420 and a visual display 430. The monitor 400 displays a desired GPS location.

FIG. 4B illustrates a front perspective view of a monitor 400 displaying a video of a combination headband and tracking device, according to the present invention. The monitor 400 includes a volume control 410, a charge port 420 and a visual display 430. The monitor 400 displays a desired video being played.

The combination headband and tracking device is used to digitally track the vantage point and location of a user. The combination headband and tracking device, through a small camera lens 130 attached to an adjustable headband 120, communicates with a separate viewing recorder GPS locator 230 to provide a visual indicator of the user's immediate environment. The monitor 400 possesses standard operative keys for control of footage and can display either video or cross-grid locality of the user. The charging cord 300 supports the viewing recorder to ensure extensive recording capabilities. The ankle bracelet 200, made of weather resistant steel, encloses with a locking mechanism 210 around the ankle of the user, serving as an additional tracking component. The combined devices comprise the combination headband and tracking device, increasing the user's chance of adequate and expeditious aide, in the event of an emergency.

The combination headband and tracking device empowers individuals with a multi-component personal tracking device. The features of a light-weight headband with recording camera, a remote video monitor and tracking ankle bracelet, ensures accurate information of a users locality by utilizing the latest technology in global positioning.

1. A combination headband and tracking device, comprises:
a headband with a snap attachment mechanism, an elastic band and a camera lens;
an ankle bracelet that includes a locking mechanism, an on and off switch and a GPS locator, where the headband and the ankle bracelet are worn by user;
a charge cord that includes a cord and an electrical plug; and
a monitor that includes a volume control, a charge port and a visual display that displays a desired GPS location or a desired video, where the desired GPS location provides a cross-grid locality of the user.
